(19) United States
(12) Patent Application Publication
(10) Pub. No.: US 2025/0215199 A1
(43) Pub. Date: Jul. 3, 2025

(54) RUBBER COMPOSITION FOR SHOE SOLES

(71) Applicant: MIZUNO CORPORATION, Osaka (JP)

(72) Inventors: Tetsuya SASAMORI, Osaka (JP); Kengo KAWAMURA, Osaka (JP); Kotaro HATA, Osaka (JP)

(73) Assignee: MIZUNO CORPORATION, Osaka (JP)

(21) Appl. No.: 18/978,075

(22) Filed: Dec. 12, 2024

(30) Foreign Application Priority Data
Dec. 28, 2023 (JP) 2023-222111

(51) Int. Cl. C08L 9/06; A43B 13/04; C08K 3/36; C08K 5/548

(52) U.S. Cl. CPC C08L 9/06; A43B 13/04; C08K 3/36; C08K 5/548; C08L 2205/025

(57) ABSTRACT

A rubber composition for shoe soles contains: a rubber component containing a modified styrene-butadiene copolymer rubber having a glass-transition temperature of −35° C. or higher; and a filler containing silica. The content of the modified styrene-butadiene copolymer rubber is 70% by mass or more with respect to the entire rubber component.

### CROSS-REFERENCE TO RELATED APPLICATION

This application claims priority to Japanese Patent Application No. 2023-222111 filed on Dec. 28, 2023, the entire disclosure of which is incorporated by reference herein.

### BACKGROUND

The present disclosure relates to a rubber composition for use as shoe soles.

The outsoles of shoes, such as sports shoes, are made of a material with a high hardness to improve grip during walking and running and resistance to abrasion.

As a material of such outsoles, a rubber composition has been suggested, for example, which contains: a rubber component (A); a lignin degradation product (B) with an aldehyde yield of 12% by mass or more by an alkaline nitrobenzene oxidation method; and an antioxidant (C). There is a description that the use of such a rubber composition makes it possible to provide a rubber composition for shoe soles which has excellent grip regardless of the conditions of the road surface (see, e.g., WO 2022/064949).

The following rubber composition is also suggested which contains a natural rubber component of about 3 phr to 90 phr, bromobutyl rubber of about 10 phr to about 90 phr, a polyterpene resin of about 2 phr to about 6 phr, a sulfur-curing component of about 0.1 phr to about 5 phr, silica of about 10 phr to about 60 phr, and a plasticizer of about 1 phr to about 10 phr, and which has a wet friction coefficient of about 0.4 to about 0.65 and a dry friction coefficient of about 0.76 to about 0.90 to improve a DIN abrasion index. There is a description that the use of such a rubber composition makes it possible to provide a rubber composition for shoe soles with excellent traction and durability (see, e.g., Japanese Unexamined Patent Application No. 2019-166317).

### SUMMARY

The rubber composition described in WO 2022/064949 has excellent dry grip and wet grip, but the resistance to abrasion has not been studied. The resistance to abrasion of the rubber composition is mentioned in Japanese Unexamined Patent Application No. 2019-166317, but a value of the DIN abrasion volume is large and the resistance to abrasion is insufficient.

It is therefore an object of the present disclosure to provide a rubber composition for shoe soles, which can provide shoe soles with excellent wet grip, dry grip, and resistance to abrasion.

In order to achieve the above object, a rubber composition for shoe soles of the present disclosure contains: a rubber component containing a modified styrene-butadiene copolymer rubber having a glass-transition temperature of −35° C. or higher; and a filler containing silica, a content of the modified styrene-butadiene copolymer rubber being 70% by mass or more with respect to the entire rubber component.

According to the present disclosure, it is possible to provide a rubber composition for shoe soles, which can provide shoe soles with excellent wet grip, dry grip, and resistance to abrasion.

### DETAILED DESCRIPTION

A preferred embodiment of the present disclosure will now be described.

The rubber composition for shoe soles of the present disclosure contains a rubber component and a filler.

### <Rubber Component>

The rubber component of the rubber composition for shoe soles of the present disclosure contains a modified styrene-butadiene copolymer rubber (hereinafter also referred to as “modified SBR”) having a glass-transition temperature of −35° C. or higher.

The use of such a modified styrene-butadiene copolymer rubber can increase the adhesive friction of the shoe soles manufactured using the rubber composition for shoe soles, thereby making it possible to exhibit dry grip (i.e., grip on a dry smooth surface).

The use of such a modified styrene-butadiene copolymer rubber increases a loss factor tan δ under specific conditions in the shoe soles manufactured using the rubber composition for shoe soles, thereby making it also possible to increase the hysteresis friction that occurs when an outsole (i.e., a viscoelastic body) rides over irregularities of a ground surface wetted with water. The shoe soles can thus exhibit wet grip (grip on a wet surface).

The “glass-transition temperature” here refers to the temperature at which the rubber state transitions to the glass state in the course of dropping the temperature.

In the rubber composition for shoe soles of the present disclosure, the content of the modified styrene-butadiene copolymer rubber is 70% by mass or more with respect to the entire rubber component (i.e., 100% by mass). This is because if the content of the modified styrene-butadiene copolymer rubber is less than 70% by mass, the shoe soles may be unable to exhibit sufficient dry grip and wet grip.

Specifically, in the rubber composition for shoe soles of the present disclosure, the rubber component contains a modified styrene-butadiene copolymer rubber having a glass-transition temperature of −35° C. or higher, and the content of the modified styrene-butadiene copolymer rubber is 70% by mass or more with respect to the entire rubber component. It is thus possible to increase the adhesive friction sufficiently and improve the dry grip reliably. Since it is possible to increase the hysteresis friction, it is possible to improve the wet grip reliably.

In order to further improve the wet grip, the content of the modified styrene-butadiene copolymer rubber is preferably 70% by mass or more, more preferably 80% by mass or more, with respect to the entire rubber component.

In order to improve the dry and wet grip and the resistance to abrasion, the bound styrene content in the modified styrene-butadiene copolymer rubber is preferably in a range of from 5% by mass to 45% by mass, more preferably in a range of from 15% by mass to 35% by mass.

The “bound styrene content” here refers to the styrene unit contained in the molecular structure of the styrene-butadiene copolymer rubber.

In order to improve the mechanical strength, the vinyl bond content of the modified styrene-butadiene copolymer rubber is preferably in a range of from 15% by mass to 65% by mass, more preferably in a rage of from 20% by mass to 60% by mass.

The “vinyl bond content” here refers to the 1,2-vinyl bond content of the styrene-butadiene copolymer rubber.

In order to improve the mechanical strength and the processability, it is preferable that the modified styrene-butadiene copolymer rubber has a Mooney viscosity (ML₁₊₄ at 100° C.) of 40 to 150.

The “Mooney viscosity” here refers to the viscosity measured pursuant to JIS K 6300-1 (2001).

Examples of the modified styrene-butadiene copolymer rubber include, for example, commercially available products, such as Y031 manufactured by Asahi Kasei Corporation, SLR4502 manufactured by Synthos schkopau GmbH, and SLR4602 manufactured by Synthos schkopau GmbH.

The rubber component in the rubber composition for shoe soles of the present disclosure may contain a rubber different from the modified styrene-butadiene copolymer rubber described above. Examples of the different rubber include, for example, a synthetic rubber, such as a butadiene rubber and an isoprene rubber, and a natural rubber. Among these rubbers, one kind may be used alone, or two or more kinds may be used in combination.

In the case of using a different rubber described above in the rubber composition for shoe soles of the present disclosure, it is preferable that the content of the different rubber is 30% by mass or less with respect to the entire rubber component (i.e., 100% by mass). This is because if the content of the different rubber is more than 30% by mass, the ratio of the modified styrene-butadiene copolymer rubber in the entire rubber component is reduced, which lowers the glass-transition temperature of the entire rubber component. Due to this drop of the glass-transition temperature, the hysteresis friction does not increase sufficiently, which may result in exhibiting the wet grip less sufficiently.

In order to further improve the wet grip, the content of the different rubber is preferably 30% by mass or less, more preferably 20% by mass or less, with respect to the entire rubber component.

The synthetic rubber and the natural rubber described above are not particularly limited, and any commercially available synthetic rubber and natural rubber can be used.

### <Filler>

The rubber composition for shoe soles of the present disclosure contains a filler in order to improve the dry and wet grip and the resistance to abrasion.

Examples of the filler include, for example, silica, carbon black, magnesium carbonate, calcium carbonate, clay, talc, and barium sulfate. Among these fillers, one kind may be used alone, or two or more kinds may be used in combination.

In addition, in order to improve the wet grip and the resistance to abrasion, a filler containing silica is used in the rubber composition for shoe soles of the present disclosure.

Examples of the silica include, for example, anhydrous silica and hydrated silica. The BET specific surface area of silica (measured pursuant to ISO 5794/1) is preferably 50 m²/g or in more, more preferably 100 m²/g or more, and even more preferably 150 m²/g or more, and is preferably 350 m²/g or less, more preferably 300 m²/g or less, and even more preferably 250 m²/g or less, in order to improve the dispersibility of the silica in the rubber composition and the resultant rubber-made body, and rubber reinforcing properties. Among these silicas, one kind may be used alone, or two or more kinds may be used in combination.

The content of the silica is preferably 40 parts by mass or more and 70 parts by mass or less with respect to 100 parts by mass of the rubber component. This is because if the silica content is less than 40 parts by mass, the resistance to abrasion does not increase sufficiently in some cases; if the silica content is more than 70 parts by mass, the processability may decrease, and the grip may decrease due to an increase in the hardness.

Examples of the silica include commercially available products, such as Nipsil VN3 manufactured by Tosoh Silica Corporation.

### <Silane Coupling Agent>

The rubber composition for shoe soles of the present disclosure may contain a silane coupling agent in order to improve the dispersibility of the filler in the rubber composition for shoe soles.

Examples of the silane coupling agent include, for example, sulfide-based coupling agents, such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl)tetrasulfide, bis(2-trimethoxysilylethyl)tetrasulfide, bis(2-triethoxysilylethyl)trisulfide, bis(4-trimethoxysilylbutyl)trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyltetrasulfide, 2-triethoxysilylethyl-N,N-dimethylthiocarbamoyltetrasulfide, and 3-triethoxysilylpropyl methacrylate monosulfide; and mercapto-based coupling agents, such as 3-mercaptopropyltrimethoxysilane, 2-mercaptoethyltriethoxysilane, and NXT and NXT-Z manufactured by Momentive Performance Materials Japan LLC. Among these silane coupling agents, one kind may be used alone, or two or more kinds may be used in combination.

Examples of the mercapto-based silane coupling agent include, for example, NXT-Z45 (condensation product of 3-octanoylthio-1-propyltriethoxysilane) manufactured by Momentive Performance Materials Japan LLC. Examples of the sulfide-based silane coupling agent include, for example, commercially available products, such as Si-69 (bis [3-(triethoxysilyl)propyl]tetrasulfide) manufactured by Evonik Japan Co., Ltd.

The content of the silane coupling agent is preferably 5 parts by mass or more and 10 parts by mass or less with respect to 100 parts by mass of the silica. This is because if the content of the silane coupling agent is less than 5 parts by mass, the dispersibility of the silica may be insufficient in some cases; if the content of the silane coupling agent is more than 10 parts by mass, the coupling effect and the silica dispersion effect may be insufficient, causing degradation of the reinforcing properties and resulting in a lower strength of the rubber composition for shoe soles.

### <Oil>

The rubber composition for shoe soles of the present disclosure may contain oil in order to improve the wet grip. Examples of the oil include, for example: mineral oils, such as paraffinic oils, naphthenic oils, and aromatic oils; vegetable oils, such as castor oil, linseed oil, tall oil fatty acid, and pine tar; ester compounds, such as fatty acid esters, phthalic acid esters, and phosphoric acid esters; and chemically synthesized oils, such as poly-α-olefins. Among these oils, one kind may be used alone, or two or more kinds may be used in combination.

The content of the oil is preferably 10 parts by mass or more and 30 parts by mass or less with respect to 100 parts by mass of the rubber component. This is because if the content of the oil is less than 10 parts by mass, the plasticizing effect by the addition cannot be obtained in some cases; if the content is more than 30 parts by mass, the resistance to abrasion may decrease.

### <Vulcanizing Agent>

The rubber composition for shoe soles of the present disclosure may contain sulfur as a vulcanizing agent.

Examples of the sulfur include, for example, powdered sulfur, precipitated sulfur, insoluble sulfur, colloidal sulfur, and surface-treated sulfur. Among these sulfurs, one kind may be used alone, or two or more kinds may be used in combination.

The content of the vulcanizing agent is preferably 0.5 parts by mass or more and 5.0 parts by mass or less with respect to 100 parts by mass of the rubber component. This is because if the content of the vulcanizing agent is less than 0.5 parts by mass, the hardness and mechanical strength of the outsoles may become insufficient; if the content is more than 5.0 parts by mass, the hardness of the outsoles may become too high.

### <Vulcanization Accelerator>

The rubber composition for shoe soles of the present disclosure may contain a vulcanization accelerator. The vulcanization accelerator is not particularly limited, and examples thereof include, for example, sulfenamide-, guanidine-, thiazole-, thiuram-, thiourea-, dithiocarbamic acid-, aldehyde-amine- or aldehyde-ammonia-, imidazoline-, and xanthate-based vulcanization accelerators. Among these, one kind may be used alone, or two or more kinds may be used in combination.

The content of the vulcanization accelerator is preferably 0.1 parts by mass or more and 2.5 parts by mass or less with respect to 100 parts by mass of the rubber component. This is because if the content of the vulcanization accelerator is less than 0.1 parts by mass, the vulcanization does not proceed sufficiently in some cases; if the content is more than 2.5 parts by mass, the vulcanization may proceed excessively.

### <Processing Aid>

The rubber composition for shoe soles of the present disclosure may contain a processing aid in order to improve the fluidity and lubricity of the rubber composition for shoe soles, reduce adhesion to a mixing machine, such as a roller or the like, and increase the mold release effect.

Examples of the processing aid include, for example, higher fatty acid esters, stearic acid, metal soaps, and polyethylene wax.

The content of the processing aid is preferably 5.0 parts by mass or less with respect to 100 parts by mass of the rubber component. This is because if the content of the processing aid is more than 5.0 parts by mass, the lubricity becomes too high, causing slide between the roller and the material and thus resulting in a difficulty in mixing the materials in the roller process.

### <Other Components

The rubber composition for shoe soles of the present disclosure may contain other components within a range not impairing the effects of the present disclosure. As other components, known additives generally used in the rubber composition for shoe soles can be used, and examples thereof include, for example: vulcanization accelerator aids, such as zinc oxide; vulcanization activators, such as polyethylene glycol; antioxidants, such as styrenated phenol; and color masterbatches, such as black masterbatch. Among these additives, one kind may be used alone, or two or more kinds may be used in combination.

In the shoe soles manufactured using the rubber composition for shoe soles of the present disclosure, a loss factor tan δ at −10° C. and a frequency of 10 Hz is 0.3 or more in order to improve the hysteresis friction and obtain excellent wet grip.

The loss factor tan δ of the shoe soles can be determined by analyzing data measured by dynamic viscoelasticity measurement for the shoe soles, using data processing software.

Specifically, the value of tan δ at −10° C. and 10 Hz is extracted using the data processing software, based on the data obtained for the shoe sole at a predetermined measurement temperature and a measurement frequency. For example, “Rheogel E4000F” manufactured by UBM can be used for the dynamic viscoelasticity measurement, and “UBM Rheo Station ver. 7.0” manufactured by UBM is used as the data processing software.

In the shoe soles manufactured using the rubber composition for shoe soles of the present disclosure, a dynamic friction coefficient μ_{Kdry} in a dry state is preferably 1.15 or more in a friction test, which will be described later, in order to improve the adhesive friction and the dry grip. It can be said that the greater the value of the dynamic friction coefficient μ_{Kdry}, the greater the frictional force and the less likely the shoe soles slip, which means that the dry grip increases.

In the shoe soles manufactured using the rubber composition for shoe soles of the present disclosure, a dynamic friction coefficient μ_{Koil} in an oil lubricated state is preferably 0.38 or more in a friction test, which will be described later, in order to increase the hysteresis friction and the wet grip. This value is considered to be the friction derived from the hysteresis friction excluding the adhesive friction. It can be said that the greater the value of the dynamic friction coefficient μ_{Koil}, the greater the frictional force due to hysteresis and the less likely the shoe soles slip, which means that the wet grip increases.

In the shoe soles manufactured using the rubber composition for shoe soles of the present disclosure, the difference between the dynamic friction coefficient μ_{Kdry} and the dynamic friction coefficient μ_{Koil} (i.e., μ_{Kdry}−μ_{Koil}) is considered to be the friction coefficient of adhesive friction. As described above, since μ_{Koil} is the friction derived from the hysteresis friction, the difference from μ_{Kdry} is the adhesive friction force. When this value is 0.7 or more, the adhesive friction increases, and the excellent dry grip can be obtained.

The “dynamic friction coefficient” here can be obtained by the method described in Examples which will be described later.

In the shoe soles manufactured using the rubber composition for shoe soles of the present disclosure, a DIN abrasion volume is preferably 160 mm³ or less in order to increase the resistance to abrasion. It can be said that the smaller the value of the DIN abrasion volume, the greater the durability, which means that the resistance to abrasion increases.

The “DIN abrasion volume” here can be obtained by the method described in Examples which will be described later.

In the shoe soles manufactured using the rubber composition for shoe soles of the present disclosure, a tensile strength is preferably 12 MPa or more in order to increase the strength.

The “tensile strength” here refers to the tensile strength measured pursuant to JIS K 6251 (2018).

### <Method of Manufacturing Rubber Composition for Shoe Soles>

Next, a method of manufacturing the rubber composition for shoe soles of the present disclosure will be described. In manufacturing the rubber composition for shoe soles of the present disclosure, raw materials, such as the rubber component, the filler, the silane coupling agent, the oil, the vulcanizing agent, the vulcanization accelerator, and the processing aid described above are put into a mixing machine first, and kneaded to produce the rubber composition for shoe soles.

Here, examples of the mixing machine include, for example, a mixing roll, a calender roll, a Banbury mixer, and a kneader.

For example, the kneading can be performed stepwise using a plurality of mixing machines: for example, a rubber component, a filler, a silane coupling agent, and a processing aid are put into a kneader and kneaded, and then the kneaded composition is moved to a roll, into which a vulcanizing agent and a vulcanization accelerator are put for kneading. All the materials may be put into a roll set at a predetermined temperature and kneaded. The rubber composition for shoe soles of the present disclosure can be produced in this manner.

### EXAMPLES

The present disclosure will now be described based on Examples. The present disclosure is not limited to these Examples, and various modifications and variations of these Examples can be made without departing from the scope and spirit of the present disclosure. The materials used for preparing the rubber composition for shoe soles are shown below.
(1) Modified SBR1 (glass-transition temperature: −30° C., bound styrene content: 26% by mass, 1,2-vinyl bond content: 49% by mass, Mooney viscosity (ML₁₊₄ at 100° C.): 65, manufactured by Asahi Kasei Corporation, trade name: Y031)
(2) Modified SBR2 (glass-transition temperature: −25° C., bound styrene content: 21% by mass, 1,2-vinyl bond content: 49% by mass, Mooney viscosity (ML₁₊₄ at 100° C.): 65, manufactured by Synthos schkopau GmbH, trade name: SLR4602)
(3) Modified SBR3 (glass-transition temperature:−35° C., bound styrene content: 20% by mass, 1,2-vinyl bond content: 42% by mass, Mooney viscosity (ML₁₊₄ at 100° C.): 60, manufactured by Synthos schkopau GmbH, trade name: SLR4502)
(4) Modified SBR4 (glass-transition temperature: −62° C., bound styrene content: 15% by mass, 1,2-vinyl bond content: 42% by mass, Mooney viscosity (ML₁₊₄ at 100° C.): 60, manufactured by Synthos schkopau GmbH, trade name: SLR3402)
(5) Unmodified SBR (bound styrene content: 46, 1,2-vinyl bond content: 16, Mooney viscosity (ML₁₊₄ at 100° C.): 45, manufactured by ENEOS Materials Corporation, trade name: ESBR0202)
(6) Butadiene rubber (manufactured by UBE Corporation, trade name: UBEPOL150L)
(7) Natural rubber (trade name: SVR-CV60)
(8) Silica (manufactured by Tosoh Silica Corporation, trade name: Nipsil VN3)
(9) Oil (manufactured by Idemitsu Kosan Co., Ltd., trade name: PW32)
(10) Silane coupling agent 1 (condensation product of 3-octanoylthio-1-propyltriethoxysilane manufactured by Momentive Performance Materials Japan LLC., trade name: NXT Z45)
(11) Silane coupling agent 2 (bis [3-(triethoxysilyl)propyl]tetrasulfide manufactured by Evonik Japan Co., Ltd., trade name: Si-69)
(12) Vulcanization accelerator aid (active zinc oxide manufactured by SEIDO CHEMICAL INDUSTRY CO., LTD., trade name: active zinc oxide AZO)
(13) Processing aid (stearic acid manufactured by NOF CORPORATION, trade name: Stearic Acid Camellia)
(14) Vulcanization activator (polyethylene glycol manufactured by Junsei Chemical Co., Ltd., trade name: PEG #4000)
(15) Antioxidant 1 (styrenated phenols manufactured by OUCHI SHINKO CHEMICAL INDUSTRIAL CO., LTD., trade name: SP-N)
(16) Antioxidant 2 (2-mercaptobenzimidazole manufactured by OUCHI SHINKO CHEMICAL INDUSTRIAL CO., LTD., trade name: MB)
(17) Vulcanizing agent (sulfur manufactured by HOSOI CHEMICAL INDUSTRY CO., LTD., trade name: Sulfur #200)
(18) Vulcanization accelerator 1 (N-oxydiethylenebenzothiazole-2-sulfenamide manufactured by OUCHI SHINKO CHEMICAL INDUSTRIAL CO., LTD., trade name: MSA)
(19) Vulcanization accelerator 2 (tetramethylthiuram monosulfide manufactured by OUCHI SHINKO CHEMICAL INDUSTRIAL CO., LTD., trade name: TS)
(20) Vulcanization accelerator 3 (diphenylguanidine manufactured by OUCHI SHINKO CHEMICAL INDUSTRIAL CO., LTD., trade name: D(D-P))
(21) Color masterbatch (natural rubber black color masterbatch manufactured by Shinko Co., Ltd.)

### Examples 1 to 14 and Comparative Examples 1 to 7

### <Preparation of Rubber Composition>

The rubber compositions for shoe soles according to Examples 1 to 14 and Comparative Examples 1 to 7 shown in Tables 1 to 3, in which the numbers represent parts by mass for the respective components, were produced by the following production method.

First, the rubber component, silica, oil, the silane coupling agents, and various additives (the vulcanization accelerator aid, the processing aid, the vulcanization activator, and the antioxidants) shown in Table 1 were mixed together and put into a kneader set at 130° C. The raw materials were kneaded for 10 minutes. Next, the kneaded composition was put into a 10-inch open roll (a temperature of 60° C.), and then the vulcanizing agent, the vulcanization accelerators, and the color masterbatch shown in Table 1 were added. The raw materials were further kneaded to prepare the rubber composition.

Next, this rubber composition was pressed for about 5 minutes using a press machine under the conditions of a temperature of 160° C. and a pressure of about 20 MPa to produce a rubber sheet 1 with a length of 200 mm, a width of 130 mm, and a thickness of 2 mm. Similarly, a rubber sheet 2 with a length of 100 mm, a width of 100 mm, and a thickness of 6 mm was produced.

### <Evaluation on Wet Grip>

The rubber composition prepared as described above was subjected to a dynamic viscoelasticity measurement under the following measurement conditions using a dynamic viscoelasticity measuring apparatus (Rheogel-E4000F manufactured by UBM). Specifically, first, the rubber sheets 1 obtained in Examples 1 to 14 and Comparative Examples 1 to 7 were cut into strips with a length of 20 mm, a width of 6 mm, and a thickness of 2 mm to obtain test pieces. Next, with both ends fixed to fixing points of the dynamic viscoelasticity measuring apparatus, each test piece was given a load to prevent loosening and was kept tensioned. In this state, a dynamic stress was applied to the test piece by driving the vibrator of the dynamic viscoelasticity measuring apparatus to cause a dynamic distortion. The dynamic stress and the dynamic distortion at this moment were detected by respective detectors, and the phase difference and the dynamic complex elastic modulus were obtained based on respective waveforms. The storage elastic modulus E′ and the loss elastic modulus E″ were determined. The measurement conditions for the dynamic viscoelasticity measurement using the dynamic viscoelasticity measuring apparatus were as follows.

### (Measurement Conditions)

Measurement mode: temperature dependence of frequency
Distorted waveform: sine wave
Measurement frequency settings: 100 Hz, 50 Hz 30 Hz, 10 Hz, 6 Hz, 3 Hz
Distortion control: 50 μm (automatic control)
Static load control: automatic static load
Measurement temperature: −20° ° C. to 50° C.
Step temperature: 2° C.
Temperature increase rate: 2° C./min
Holding time: 0 sec
Offset temperature: −30° C.

Next, from the data obtained through the measurement using the dynamic viscoelasticity measuring apparatus, data on tan δ (−10° C.) at −10° C. and 10 Hz was extracted. The wet grip was evaluated based on the following evaluation criteria. The results are shown in Tables 1 to 3.
tan δ (at −10° C.) is 0.3 or more . . . Good
tan δ (at −10° C.) is less than 0.3 . . . Poor

### <Evaluation on Dry Grip>

The dynamic friction coefficient on the surface of each of the rubber compositions prepared in Examples 1 to 14 and Comparative Examples 1 to 7 was measured by the following test method.

More specifically, the rubber sheet (each of the rubber sheets 1 obtained in Examples 1 to 14 and Comparative Examples 1 to 7), having a thickness of 2 mm and fixed on a sliding table, was loaded with a line contact jig of 10 mm width under a weight of 250 g at 23° C.±3° C. under an atmosphere pressure, using a friction tester (manufactured by Trinity-Lab. Inc., trade name: TL201Tt). After that, the rubber sheet was slid 20 mm at a sliding speed of 10 mm/s; the dynamic friction coefficient between 7 mm and 13 mm was measured and defined as the dynamic friction coefficient μ_{Kdry} in a dry state.

The measurement was performed three times, and the average value of the dynamic friction coefficients μ_{Kdry} of the three measurements was calculated and used as the dynamic friction coefficient on the surface of the rubber composition.

Further, the dynamic friction coefficient μ_{Koil} in an oil state was measured by a measurement method similar to that for the dynamic friction coefficient μ_{Kdry} in the dry state described above, with the surfaces of the rubber sheets having a thickness of 2 mm described above (the rubber sheets 1 obtained in Examples 1 to 14 and Comparative Examples 1 to 7) sufficiently wetted with silicone oil (manufactured by Shin-Etsu Chemical Co., Ltd., with a viscosity of 100 cSt).

The difference between the measured dynamic friction coefficient μ_{Kdry} and the measured dynamic friction coefficient μ_{Koil} (i.e., μ_{Kdry}−μ_{Koil}) was calculated. The dry grip was evaluated based on the following evaluation criteria. The results are shown in Tables 1 to 3.
μ_{Kdry}−μ_{Koil} is 0.7 or more . . . Good
μ_{Kdry}−μ_{Koil} is less than 0.7 . . . Poor

### <Evaluation on Resistance to Abrasion>

The rubber compositions prepared in Examples 1 to 14 and Comparative Examples 1 to 7 were subjected to a DIN abrasion test pursuant to JIS K 6264-2:2005 using a DIN abrasion tester (manufactured by Gotech Testing Machines Inc., trade name: GT-7012-D).

A circular test piece with a diameter of 16 mm was punched out from each of the prepared rubber sheets having a thickness of 6 mm (i.e., the rubber sheets 2 obtained in Examples 1 to 14 and Comparative Examples 1 to 7) and was used as a test piece for the DIN abrasion test.

The test piece was set in a tester and abraded by sliding it 40 m in total while rotating it at a pressing load of 10 N. The test piece was slid on a drum around which an abrasive cloth #60 was wrapped (the dram diameter was 150 mm, and a rotation speed was 40 rpm). The DIN abrasion volume [mm³] was then calculated based on the mass of reduction of the test piece due to the abrasion.

The resistance to abrasion was then evaluated based on the following evaluation criteria. The results are shown in Tables 1 to 3.
DIN abrasion volume is 160 mm³ or less . . . Good
DIN abrasion volume is more than 160 mm³ . . . Poor

### <Evaluation on Strength>

The tensile strength [MPa] of each of the rubber compositions prepared in Examples 1 to 14 and Comparative Examples 1 to 7 was measured pursuant to JIS K 6251 (2018). More specifically, a dumbbell-shaped sample according to a dumbbell No. 3 test piece was prepared, and a tensile test was performed under the conditions of a temperature of 23° C. and a tension speed of 500 mm/min using a tensile tester (manufactured by Instron, trade name: Instron 3365), and the tensile strength [MPa] at the time of breakage of the sample was measured.

The strength was evaluated based on the following evaluation criteria. The results are shown in Tables 1 to 3.
Tensile strength is 12 MPa or more . . . Good
Tensile strength is less than 12 MPa . . . Poor

TABLE 1

| | | EXAMPLES | | | | | | | |
|---|---|---|---|---|---|---|---|---|---|
| | | 1 | 2 | 3 | 4 | 5 | 6 | 7 | 8 |
| Mixing | Modified SBR1 | 100.0 | | | | | 90.0 | 70.0 | |
| Ratio | Modified SBR2 | | 100.0 | | 90.0 | 70.0 | | | |
| (parts by | Modified SBR3 | | | 100.0 | | | | | 90.0 |
| mass) | Modified SBR4 | | | | | | | | |
| | Unmodified SBR | | | | | | | | |
| | Butadiene Rubber | | | | 10.0 | 30.0 | 10.0 | 30.0 | 10.0 |
| | Natural Rubber | | | | | | | | |
| | Silica | 40.0 | 40.0 | 40.0 | 40.0 | 40.0 | 40.0 | 40.0 | 40.0 |
| | Oil | 10.0 | 10.0 | 10.0 | 10.0 | 10.0 | 10.0 | 10.0 | 10.0 |
| | Silane Coupling Agent 1 | 2.0 | 2.0 | 2.0 | 2.0 | 2.0 | 2.0 | 2.0 | 2.0 |
| | Silane Coupling Agent 2 | | | | | | | | |
| | Vulcanization Accelerator Aid | 1.0 | 1.0 | 1.0 | 1.0 | 1.0 | 1.0 | 1.0 | 1.0 |
| | Processing Aid | 1.0 | 1.0 | 1.0 | 1.0 | 1.0 | 1.0 | 1.0 | 1.0 |
| | Vulcanization Activator | 1.0 | 1.0 | 1.0 | 1.0 | 1.0 | 1.0 | 1.0 | 1.0 |
| | Antioxidant 1 | 2.0 | 2.0 | 2.0 | 2.0 | 2.0 | 2.0 | 2.0 | 2.0 |
| | Antioxidant 2 | 1.0 | 1.0 | 1.0 | 1.0 | 1.0 | 1.0 | 1.0 | 1.0 |
| | Vulcanizing Agent | 1.0 | 1.0 | 1.0 | 1.0 | 1.0 | 1.0 | 1.0 | 1.0 |
| | Vulcanization Accelerator 1 | 1.5 | 1.5 | 1.5 | 1.5 | 1.5 | 1.5 | 1.5 | 1.5 |
| | Vulcanization Accelerator 2 | 0.7 | 0.7 | 0.7 | 0.7 | 0.7 | 0.7 | 0.7 | 0.7 |
| | Vulcanization Accelerator 3 | 0.5 | 0.5 | 0.5 | 0.5 | 0.5 | 0.5 | 0.5 | 0.5 |
| | Color Masterbatch | 0.5 | 0.5 | 0.5 | 0.5 | 0.5 | 0.5 | 0.5 | 0.5 |
| | Sum | 162.20 | 162.20 | 162.20 | 162.20 | 162.20 | 162.20 | 162.20 | 162.20 |
| Evaluation | tanδ (−10° C.) [—] | 1.19 | 1.16 | 0.61 | 0.83 | 0.31 | 0.73 | 0.30 | 0.39 |
| | μ_{Kdry} [—] | 1.49 | 1.28 | 1.74 | 1.87 | 1.38 | 1.80 | 1.15 | 1.42 |
| | μ_{Koil} [—] | 0.55 | 0.48 | 0.45 | 0.51 | 0.45 | 0.53 | 0.40 | 0.38 |
| | μ_{Kdry} − μ_{Koil} [—] | 0.94 | 0.80 | 1.29 | 1.36 | 0.93 | 1.27 | 0.75 | 1.04 |
| | DIN Abrasion Volume [mm³] | 145 | 159 | 130 | 115 | 93 | 111 | 87 | 123 |
| | Tensile Strength [MPa] | 16 | 15 | 14 | 17 | 14 | 16 | 16 | 16 |

TABLE 2

| | | EXAMPLES | | | | | |
|---|---|---|---|---|---|---|---|
| | | 9 | 10 | 11 | 12 | 13 | 14 |
| Mixing | Modified SBR1 | | | | | | |
| Ratio | Modified SBR2 | 100.0 | 100.0 | 100.0 | 100.0 | 100.0 | 70.0 |
| (parts by | Modified SBR3 | | | | | | |
| mass) | Modified SBR4 | | | | | | |
| | Unmodified SBR | | | | | | |
| | Butadiene Rubber | | | | | | |
| | Natural Rubber | | | | | | 30.0 |
| | Silica | 40.0 | 40.0 | 40.0 | 70.0 | 70.0 | 40.0 |
| | Oil | 10.0 | 10.0 | 10.0 | 10.0 | 30.0 | 10.0 |
| | Silane Coupling Agent 1 | | 4.0 | 4.4 | 3.5 | 3.5 | 2.0 |
| | Silane Coupling Agent 2 | 2.0 | | | | | |
| | Vulcanization Accelerator Aid | 1.0 | 1.0 | 1.0 | 1.0 | 1.0 | 1.0 |
| | Processing Aid | 1.0 | 1.0 | 1.0 | 1.0 | 1.0 | 1.0 |
| | Vulcanization Activator | 1.0 | 1.0 | 1.0 | 1.0 | 1.0 | 1.0 |
| | Antioxidant 1 | 2.0 | 2.0 | 2.0 | 2.0 | 2.0 | 2.0 |
| | Antioxidant 2 | 1.0 | 1.0 | 1.0 | 1.0 | 1.0 | 1.0 |
| | Vulcanizing Agent | 1.0 | 1.0 | 1.0 | 1.0 | 1.0 | 1.0 |
| | Vulcanization Accelerator 1 | 1.5 | 1.5 | 1.5 | 1.5 | 1.5 | 1.5 |
| | Vulcanization Accelerator 2 | 0.7 | 0.7 | 0.7 | 0.7 | 0.7 | 0.7 |
| | Vulcanization Accelerator 3 | 0.5 | 0.5 | 0.5 | 0.5 | 0.5 | 0.5 |
| | Color Masterbatch | 0.5 | 0.5 | 0.5 | 0.5 | 0.5 | 0.5 |
| | Sum | 162.20 | 164.20 | 164.60 | 193.70 | 213.70 | 162.20 |
| Evaluation | tanδ (−10° C.) [—] | 1.04 | 1.18 | 1.21 | 0.53 | 0.35 | 0.69 |
| | μ_{Kdry} [—] | 1.54 | 1.86 | 1.95 | 1.38 | 1.54 | 1.81 |
| | μ_{Koil} [—] | 0.52 | 0.45 | 0.46 | 0.44 | 0.41 | 0.50 |
| | μ_{Kdry} − μ_{Koil} [—] | 1.02 | 1.41 | 1.49 | 0.94 | 1.13 | 1.31 |
| | DIN Abrasion Volume [mm³] | 152 | 148 | 157 | 146 | 141 | 152 |
| | Tensile Strength [MPa] | 16 | 14 | 11 | 22 | 20 | 20 |

TABLE 3

| | | COMPARATIVE EXAMPLES | | | | | | |
|---|---|---|---|---|---|---|---|---|
| | | 1 | 2 | 3 | 4 | 5 | 6 | 7 |
| Mixing Ratio | Modified SBR1 | | | | | | | |
| (parts by | Modified SBR2 | | 60.0 | | | | | |
| mass) | Modified SBR3 | | | | | | | |
| | Modified SBR4 | 100.0 | | | | | | |
| | Unmodified SBR | | | 100.0 | 75.0 | 50.0 | 25.0 | |
| | Butadiene Rubber | | 40.0 | | 25.0 | 50.0 | 75.0 | 100.0 |
| | Natural Rubber | | | | | | | |
| | Silica | 40.0 | 40.0 | 40.0 | 40.0 | 40.0 | 40.0 | 40.0 |
| | Oil | 10.0 | 10.0 | 10.0 | 10.0 | 10.0 | 10.0 | 10.0 |
| | Silane Coupling Agent 1 | 2.0 | 2.0 | 2.0 | 2.0 | 2.0 | 2.0 | 2.0 |
| | Silane Coupling Agent 2 | | | | | | | |
| | Vulcanization Accelerator Aid | 1.0 | 1.0 | 1.0 | 1.0 | 1.0 | 1.0 | 1.0 |
| | Processing Aid | 1.0 | 1.0 | 1.0 | 1.0 | 1.0 | 1.0 | 1.0 |
| | Vulcanization Activator | 1.0 | 1.0 | 1.0 | 1.0 | 1.0 | 1.0 | 1.0 |
| | Antioxidant 1 | 2.0 | 2.0 | 2.0 | 2.0 | 2.0 | 2.0 | 2.0 |
| | Antioxidant 2 | 1.0 | 1.0 | 1.0 | 1.0 | 1.0 | 1.0 | 1.0 |
| | Vulcanizing Agent | 1.0 | 1.0 | 1.0 | 1.0 | 1.0 | 1.0 | 1.0 |
| | Vulcanization Accelerator 1 | 1.5 | 1.5 | 1.5 | 1.5 | 1.5 | 1.5 | 1.5 |
| | Vulcanization Accelerator 2 | 0.7 | 0.7 | 0.7 | 0.7 | 0.7 | 0.7 | 0.7 |
| | Vulcanization Accelerator 3 | 0.5 | 0.5 | 0.5 | 0.5 | 0.5 | 0.5 | 0.5 |
| | Color Masterbatch | 0.5 | 0.5 | 0.5 | 0.5 | 0.5 | 0.5 | 0.5 |
| | Sum | 162.20 | 162.20 | 162.20 | 162.20 | 162.20 | 162.20 | 162.20 |
| Evaluation | tanδ (−10° C.) [—] | 0.12 | 0.17 | 0.92 | 0.83 | 0.61 | 0.34 | 0.10 |
| | μ_{Kdry} [—] | 1.78 | 1.06 | 1.52 | 0.96 | 0.78 | 0.68 | 0.77 |
| | μ_{Koil} [—] | 0.48 | 0.37 | 0.59 | 0.35 | 0.30 | 0.24 | 0.20 |
| | μ_{Kdry} − μ_{Koil} [—] | 1.30 | 0.69 | 0.93 | 0.61 | 0.48 | 0.44 | 0.57 |
| | DIN Abrasion Volume [mm³] | 87 | 79 | 216 | 69 | 45 | 33 | 31 |
| | Tensile Strength [MPa] | 15 | 14 | 28 | 29 | 24 | 20 | 18 |

As shown in Table 1, it is found that the wet grip is excellent, since the tan δ (−10° C.) is 0.3 or more, in each of Examples 1 to 14 using the rubber composition for shoe soles which contains silica and a rubber component containing a modified styrene-butadiene copolymer rubber having a glass-transition temperature of −35° C. or higher, and the content of the modified styrene-butadiene copolymer rubber is 70% by mass or more with respect to the entire rubber component. It is also found that the Examples have excellent dry grip since μ_{Kdry}−μ_{Koil} is 0.7 or more. It is also found that the Examples have excellent resistance to abrasion since the DIN abrasion volume is 160 mm³ or less. It is also found that the Examples have excellent strength since the tensile strength is 12 MPa or more.

### INDUSTRIAL APPLICABILITY

As described above, the present disclosure is particularly useful as a rubber composition for use as shoe soles.

What is claimed is:

1. A rubber composition for shoe soles, the rubber composition comprising:
a rubber component containing a modified styrene-butadiene copolymer rubber having a glass-transition temperature of −35° C. or higher; and
a filler containing silica,
a content of the modified styrene-butadiene copolymer rubber being 70% by mass or more with respect to the entire rubber component.

2. The rubber composition of claim 1, comprising:
a silane coupling agent, wherein
a content of the silane coupling agent is 5 parts by mass or more and 10 parts by mass or less with respect to 100 parts by mass of the silica.

3. The rubber composition of claim 1, wherein
a content of the silica is 40 parts by mass or more and 70 parts by mass or less with respect to 100 parts by mass of the rubber component.

4. The rubber composition of claim 1, wherein
the rubber component contains a rubber different from the modified styrene-butadiene copolymer rubber, and
a content of the different rubber is 30% by mass or less with respect to the entire rubber component.
